(19) United States
(12) Patent Application Publication
(10) Pub. No.: US 2025/0045536 A1
(43) Pub. Date: Feb. 6, 2025

(54) Context-Aware Speech Interpretation

(71) Applicant: Dandelion Days, LLC, San Juan, PR (US)

(72) Inventor: Sarah Bennett, San Juan, PR (US)

(73) Assignee: Dandelion Days, LLC, San Juan, PR (US)

(21) Appl. No.: 18/782,952

(22) Filed: Jul. 24, 2024

Related U.S. Application Data
(60) Provisional application No. 63/516,723, filed on Jul. 31, 2023.

(51) Int. Cl. G06F 40/58; G10L 15/16; G10L 15/18

(52) U.S. Cl. CPC G06F 40/58; G10L 15/16; G10L 15/1815; G10L 15/1822

(57) ABSTRACT

Provided herein are computerized methods, media, and systems for real-time interpretation, comprising transcribing to extracted speech from a speaker into text; interpreting the transcribed text for a user using a context-aware machine translation system to produce an interpreted output, wherein the interpretation considers the speaker's intent and the user's context to translate the extracted speech from a source language into at least one target language of the interpreted output, and exporting the interpreted output.

This application claims the benefit of priority of the U.S. Provisional Patent Application Ser. No. 63/516,723 filed on Jul. 31, 2023, the disclosure of which is incorporated by reference in its entirety for all purposes.

The present disclosure address relates to methods, media, and systems for speech extraction, transcription, context-aware interpretation, and exporting interpreted text.

Development in speech-to-text conversion and language translation is driven by the need for effective communication across language barriers in an increasingly interconnected world. Current systems employ a combination of speech recognition, natural language processing, and machine translation. However, there remain certain challenges in achieving real-time interpretation, translation accuracy, and customization per user preferences and context. Limitations in each of these individual components can impact the overall performance and practicality of deployed solutions. While progress has been made, certain aspects such as latency, handling of context-specific information, and sensitivity toward human speech patterns still leave room for improvement.

Existing technologies either do not involve real-time interpretation or fail to provide translations that consider a user's context and the speaker's intent. Moreover, the art has not provided comprehensive solutions to linguistic challenges, such as out-of-vocabulary words, idioms or homophones, or providing personalized translations based on user-specific preferences.

The present disclosure addresses these problems by providing a computerized method for real-time interpretation. In addition to the principal solution, the present disclosure includes several embodiments extending its capabilities. These additional embodiments cover various aspects, such as handling linguistic challenges, assessing translation reliability, providing multilingual closed captioning and subtitling, simultaneous interpretation, language identification and adaptation, customized and personalized translation, multi-speaker translation, and secure translation in noise-sensitive or confidential environments. In certain embodiments, sophisticated algorithms offer improved speech recognition, better understanding of context, and/or reduced latency. As a result, user experience is enhanced during cross-lingual communication, aiding the efficient exchange of information across language and cultural barriers. Together, these embodiments provide a comprehensive, versatile, and adaptable framework for real-time interpretation.

In particular, the present disclosure provides a computerized method of real-time interpretation, comprising: transcribing to extracted speech from a speaker into text; interpreting the transcribed text for a user using a context-aware machine translation system to produce an interpreted output, wherein the interpretation considers the speaker's intent and the user's context to translate the extracted speech from a source language into at least one target language of the interpreted output; and exporting the interpreted output.

The present disclosure also provides a non-transitory computer readable medium storing instructions, which when executed by a processor, perform a real-time interpretation method, the method comprising: transcribing extracted speech from a speaker into text; interpreting the transcribed text for a user using a context-aware machine translation system to produce an interpreted output, wherein the interpretation considers the speaker's intent and the user's context to translate the extracted speech from a source language into at least one target language of the interpreted output; and exporting the interpreted output.

The present disclosure further provides a real-time interpretation system, comprising: a speech extraction module configured to extract speech from a speaker; a transcription module configured to transcribe the extracted speech into text; a context-aware machine translation module configured to interpret the transcribed text for a user, wherein the interpretation considers the speaker's intent and the user's context to translate the extracted speech from a source language into at least one target language of an interpreted output; and an exporting module configured to export the interpreted output.

Additional embodiments and features are set forth in part in the description that follows, and in part will become apparent to those skilled in the art upon examination of the specification, or may be learned by the practice of the embodiments discussed herein. A further understanding of the nature and advantages of certain embodiments may be realized by reference to the remaining portions of the specification and the drawings, which form a part of this disclosure.

### BRIEF DESCRIPTION OF THE DRAWINGS

The disclosure will be readily understood by the following detailed description in conjunction with the accompanying drawings, wherein like reference numerals designate like structural elements. The drawings provide exemplary embodiments or aspects of the disclosure and do not limit the scope of the disclosure.

FIG. 1 illustrates a system configured for context-aware interpretation.

FIG. 2 illustrates a method for providing context-aware interpretation.

FIG. 3 is a block diagram illustrating an example of a suitable computing system environment in which aspects of the present disclosure may be implemented.

### DETAILED DESCRIPTION

Voice-based input presents several challenges compared to text-based input, including the accurate speech recognition that accounts for factors, such as accents, dialects, background noise, and speech impediments. Additionally, voice-based systems handle ambiguity and homophones, correctly identifying intended words based on context. These systems also require natural language understanding to process variations in sentence structure, grammar, and colloquial expressions. Furthermore, processing continuous speech and segmenting it into meaningful units can be more challenging than handling discrete text input. Providing user feedback and error correction in voice-based systems can be more complicated than in text-based systems, as users may rely on auditory feedback or switch to a visual interface to review and correct their input.

By incorporating the nuances of the source language and cultural subtleties, the AI system ensures a more accurate and coherent translation that retains the original meaning and intent of the speaker. Additionally, the context-aware AI system adapts to various user scenarios, intelligently adjusting its translations based on the specific situation or domain, resulting in more relevant and appropriate translations for the end user.

In certain embodiments, a real-time interpretation method may include transcribing extracted speech from a speaker into text, interpreting the transcribed text for a user using a context-aware machine translation system to produce an interpreted output, and exporting the interpreted output. The interpretation considers the speaker's intent and the user's context to translate the extracted speech from a source language into at least one target language of the interpreted output.

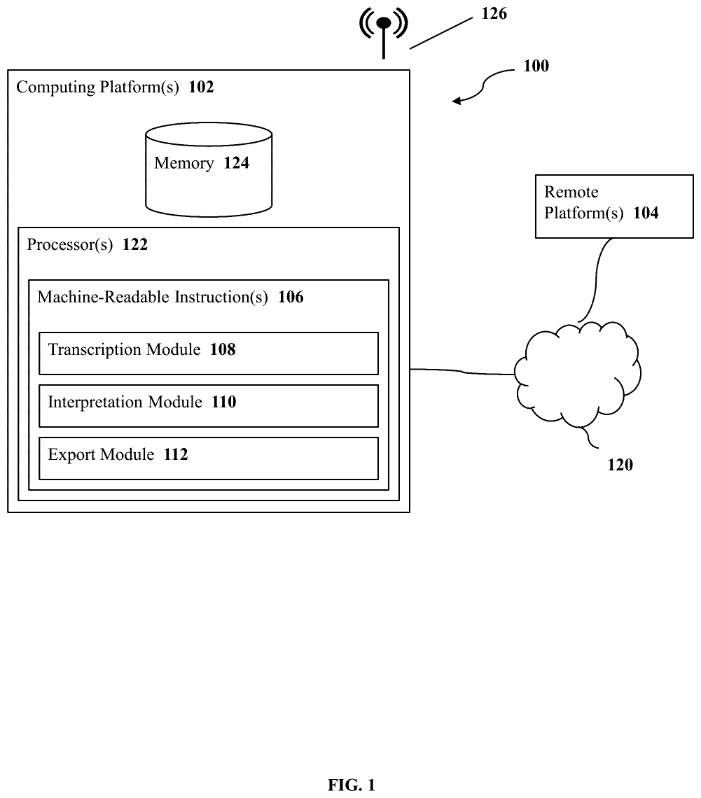

FIG. 1 illustrates a system configured for providing real-time interpretation, in accordance with one or more embodiments. In some cases, system 100 may include one or more computing platforms 102. The one or more remote computing platforms 102 may be communicably coupled with one or more remote platforms 104. In some cases, users may access system 100 via remote platform(s) 104.

The one or more computing platforms 102 may be configured by machine-readable instructions 106. Machine-readable instructions 106 may include modules. The modules may be implemented as one or more of functional logic, hardware logic, electronic circuitry, software modules, and the like. The modules may include one or more of transcription module 108, interpretation module 110, and export module 112, and/or other modules.

Transcription module 108 is responsible for transcribing the extracted speech into text. The context-aware machine translation module, referred to as interpretation module 110, interprets the transcribed text for a user, taking into account the speaker's intent as well as the user's context in translating the extracted speech from a source language into at least one target language of an interpreted output. Lastly, the export module 112 is configured to export the interpreted output for the user's reference or use. In certain embodiments, the system further comprises a speech extraction module configured to extract speech from a speaker.

In some cases, the one or more computing platforms 102, may be communicatively coupled to the remote platform(s) 104. In some cases, the communicative coupling may include communicative coupling through a networked environment 120. The networked environment 120 may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which one or more computing platforms 102 and remote platform(s) 104 may be operatively linked via some other communication coupling. The one or more one or more computing platforms 102 may be configured to communicate with the networked environment 120 via wireless or wired connections. In addition, in an embodiment, the one or more computing platforms 102 may be configured to communicate directly with each other via wireless or wired connections. Examples of one or more computing platforms 102 may include, but is not limited to, smartphones, wearable devices, tablets, laptop computers, desktop computers, Internet of Things (IoT) device, or other mobile or stationary devices. In an embodiment, system 100 may also include one or more hosts or servers, such as the one or more remote platforms 104 connected to the networked environment 120 through wireless or wired connections. According to one embodiment, remote platforms 104 may be implemented in or function as base stations (which may also be referred to as Node Bs or evolved Node Bs (eNBs)). In other embodiments, remote platforms 104 may include web servers, mail servers, application servers, etc. According to certain embodiments, remote platforms 104 may be standalone servers, networked servers, or an array of servers.

The one or more computing platforms 102 may include one or more processors 122 for processing information and executing instructions or operations. One or more processors 122 may be any type of general or specific purpose processor. In some cases, multiple processors 122 may be used per other embodiments. In fact, the one or more processors 122 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more processors 122 may be remote from the one or more computing platforms 102, such as disposed within a remote platform like the one or more remote platforms 122 of FIG. 1.

The one or more processors 122 may perform functions associated with the operation of system 100 which may include, for example, precoding of antenna gain/phase parameters, encoding and decoding of individual bits forming a communication message, formatting of information, and overall control of the one or more computing platforms 102, including processes related to management of communication resources.

The one or more computing platforms 102 may further include or be coupled to a memory 124 (internal or external), which may be coupled to one or more processors 122, for storing information and instructions that may be executed by one or more processors 122. Memory 124 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 124 can consist of any combination of random access memory (RAM), read only memory (ROM), static storage such as a magnetic or optical disk, hard disk drive (HDD), or any other type of non-transitory machine or computer readable media. The instructions stored in memory 124 may include program instructions or computer program code that, when executed by one or more processors 122, enable the one or more computing platforms 102 to perform tasks as described herein.

In some embodiments, one or more computing platforms 102 may also include or be coupled to one or more antennas 126 for transmitting and receiving signals and/or data to and from one or more computing platforms 102. The one or more antennas 126 may be configured to communicate via, for example, a plurality of radio interfaces that may be coupled to the one or more antennas 126. The radio interfaces may correspond to a plurality of radio access technologies including one or more of LTE, 5G, WLAN, Bluetooth, near field communication (NFC), radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

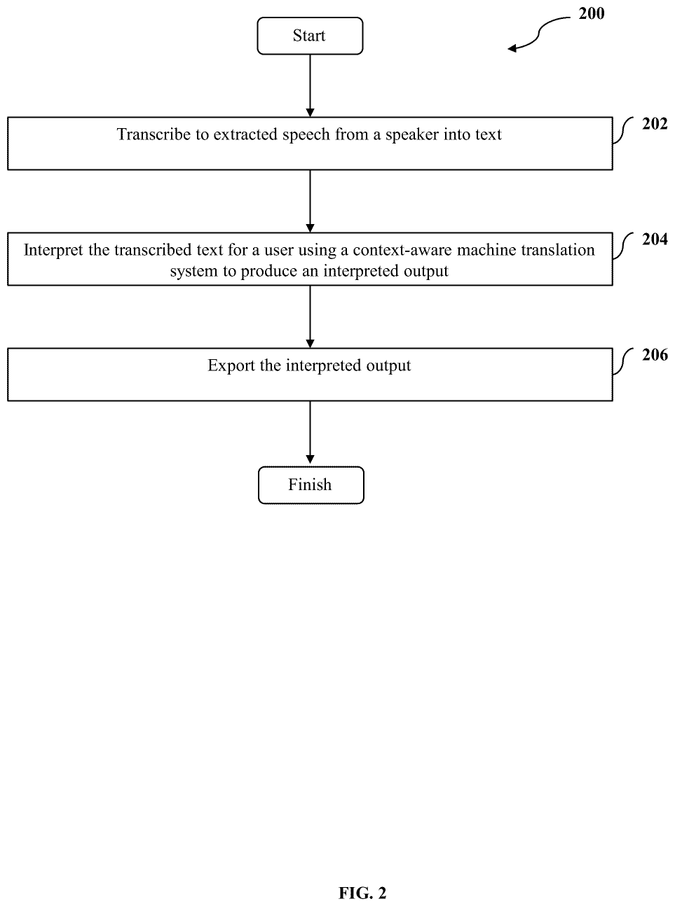

FIG. 2 illustrates an example flow diagram of method 200 for real-time interpretation, according to one embodiment. Method 200 may include extracting speech from a speaker at block 202. The method 200 may include transcribing the extracted speech into text at block 204. Method 200 may include interpreting the transcribed text for a user using a context-aware machine translation system at block 206, with the interpretation considering the speaker's intent and the user's context to translate the extracted speech from a source language into at least one target language of an interpreted output. Method 200 may include exporting the interpreted output at block 208, making the generated output available for the user's reference or use.

In some cases, method 200 may be performed by one or more hardware processors, such as the processors 122 of FIG. 1, configured by machine-readable instructions, such as the machine-readable instructions 106 of FIG. 1. In this aspect, the method 200 may be configured to be implemented by the modules, such as the modules 108, 110, and/or 112 discussed above in FIG. 1.

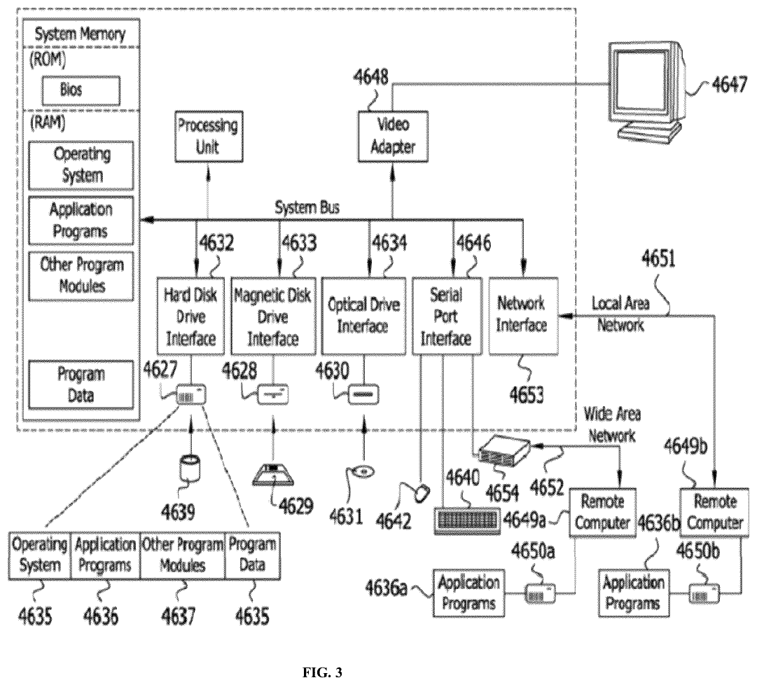

With reference to FIG. 3, an exemplary system for implementing aspects of the disclosure includes a general-purpose computing device in the form of a conventional computer 4620, including a processing unit 4621, a system memory 4622, and a system bus 4623 that couples various system components, including the system memory 4622 to the processing unit 4621. The system bus 4623 may be any of several bus structures, including a memory bus or memory controller, a peripheral bus, and a local bus using various bus architectures. The system memory includes read-only memory (ROM) 4624 and random-access memory (RAM) 4625. A basic input/output system (BIOS) 4626, containing the basic routines that help transfer information between elements within the computer 4620, such as during startup, may be stored in ROM 4624.

The computer 4620 may also include a magnetic hard disk drive 4627 for reading from and writing to a magnetic hard disk 4639, a magnetic disk drive 4628 for reading from or writing to a removable magnetic disk 4629, and an optical disk drive 4630 for reading from or writing to removable optical disk 4631, such as a CD-ROM or other optical media. The magnetic hard disk drive 4627, magnetic disk drive 4628, and optical disk drive 4630 are connected to the system bus 4623 by a hard disk drive interface 4632, a magnetic disk drive-interface 4633, and an optical drive interface 4634, respectively. The drives and their associated computer-readable media provide nonvolatile storage of computer-executable instructions, data structures, program modules, and other data for the computer 4620. Although the exemplary environment described herein employs a magnetic hard disk 4639, a removable magnetic disk 4629, and a removable optical disk 4631, other types of computer-readable media for storing data can be used, including magnetic cassettes, flash memory cards, digital video disks, Bernoulli cartridges, RAMs, ROMs, and the like.

Program code means comprising one or more program modules may be stored on the hard disk 4639, magnetic disk 4629, optical disk 4631, ROM 4624, and/or RAM 4625, including an operating system 4635, one or more application programs 4636, other program modules 4637, and program data 4638. A user may enter commands and information into the computer 4620 through keyboard 4640, pointing device 4642, or other input devices (not shown), such as a microphone, joystick, gamepad, satellite dish, scanner, or the like. These and other input devices are often connected to the processing unit 4621 through a serial port interface 4646 coupled to the system bus 4623. Alternatively, the input devices may be connected by other interfaces, such as a parallel port, a game port, or a universal serial bus (USB). A monitor 4647 or another display device is also connected to system bus 4623 via an interface, such as video adapter 4648. In addition to the monitor, personal computers typically include other peripheral output devices (not shown), such as speakers and printers.

The computer 4620 may operate in a networked environment using logical connections to one or more remote computers, such as remote computers 4649a and 4649b. Remote computers 4649a and 4649b may each be another personal computer, a server, a router, a network PC, a peer device, or another common network node. These typically include many or all the elements described above relative to the computer 4620. However, only memory storage devices 4650a and 4650b and their associated application programs 4636a and 4636b have been illustrated in FIG. 3. The logical connections depicted in FIG. 3 include a local area network (LAN) 4651 and a wide area network (WAN) 4652 presented here by way of example and not limitation. Such networking environments are commonplace in office-wide or enterprise-wide computer networks, intranets, and the Internet.

When used in a LAN networking environment, the computer 4620 is connected to the local network 4651 through a network interface or adapter 4653. When used in a WAN networking environment, the computer 4620 may include a modem 4654, a wireless link, or other means for establishing communications over the wide area network 4652, such as the Internet. The modem 4654, internal or external, is connected to the system bus 4623 via the serial port interface 4646. In a networked environment, program modules depicted relative to the computer 4620 or portions thereof may be stored in the remote memory storage device. It will be appreciated that the network connections shown are exemplary and other means of establishing communications over wide area network 4652 may be used.

One or more aspects of the disclosure may be embodied in computer-executable instructions (i.e., software), such as a software object, routine, or function (collectively referred to herein as a software) stored in system memory 4624 or nonvolatile memory 4635 as application programs 4636, program modules 4637, and/or program data 4638. The software may alternatively be stored remotely, such as on remote computers 4649a and 4649b with remote application programs 4636b. Generally, program modules include routines, programs, objects, components, data structures, etc., that perform particular tasks or implement particular abstract data types when executed by a processor in a computer or other device. The computer-executable instructions may be stored on a computer-readable medium such as a hard disk 4627, optical disk 4630, solid-state memory, RAM 4625, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

A programming interface (or, more simply, interface) may be viewed as any mechanism, process, or protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of another component(s). The term “segment of code” in the preceding sentence is intended to include one or more instructions or lines of code. It includes, e.g., code modules, objects, subroutines, functions, and so on, regardless of the terminology applied or whether the code segments are separately compiled, or whether the code segments are provided as a source, intermediate, or object code, whether the code segments are used in a run-time system or process, or whether they are located on the same or different machines or distributed across multiple machines, or whether the functionality represented by the segments of code are implemented wholly in software, wholly in hardware, or a combination of hardware and software. By way of example, and not limitation, terms such as application programming interface (API), entry point, method, function, subroutine, remote procedure call, and component object model (COM) interface are encompassed within the definition programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing, and content of the information. In this regard, the underlying transport medium itself may be unimportant to the operation of the interface, whether the medium is wired or wireless, or a combination of both, as long as the information is transported in the manner defined by the interface. In certain situations, information may not be passed in one or both directions in the conventional sense, as the information transfer may be either via another mechanism (e.g., information placed in a buffer, file, etc. separate from information flow between the code segments) or non-existent, as when one code segment accesses functionality performed by a second code segment. An aspect applies based on the situation, such as whether the code segments are part of a system in a loosely coupled or tightly coupled configuration. So this list should be considered illustrative and non-limiting.

This notion of a programming interface is known to those skilled in the art and is clear from the provided detailed description. Some illustrative implementations of a programming interface may also include factoring, redefinition, inline coding, divorce, and rewriting, to name a few. There are, however, other ways to implement a programming interface, and, unless expressly excluded, these, too, are intended to be encompassed by the claims set forth at the end of this specification.

“Computing device” refers to any mobile device, such as a smartphone, a cell phone, a pager, a personal digital assistant (PDA, e.g., with GPRS NIC), a mobile computer with a cellular radio, or the like. A typical mobile device is a wireless data access-enabled device (e.g., an iPhone® smartphone, a Blackberry® smartphone, a Nexus One™ smartphone, an iPad™ device, or the like) capable of sending and wirelessly receiving data using protocols like the Internet Protocol (IP) and the wireless application protocol (WAP). This allows users to access information via wireless devices, such as smartphones, mobile phones, pagers, two-way radios, communicators, etc. Many wireless networks support wireless data access, including, but not limited to, CDPD, CDMA, GSM, PDC, PHS, TDMA, FLEX, ReFLEX, iDEN, TETRA, DECT, DataTAC, Mobitex, EDGE, and other 2G, 3G, 4G, and LTE technologies, and it operates with many handheld device operating systems, such as PalmOS, EPOC, Windows CE, FLEXOS, OS/9, JavaOS, iOS, and Android.

Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smartphone that operates over General Packet Radio Services (GPRS), a data technology for GSM networks. In addition to conventional voice communication, a given mobile device can communicate with another such device via many different types of message transfer techniques, including short message service (SMS), enhanced SMS (EMS), multimedia message (MMS), email WAP, paging, or other known or later-developed wireless data formats. Although many of the examples provided herein are implemented on a mobile device, the examples may similarly be implemented on any suitable “computing device.”

Embodiments within the scope of the present disclosure also include computer-readable media and computer-readable storage media for carrying or having computer-executable instructions or data structures stored thereon. Such computer-readable media can be any available media accessed by a general-purpose or special-purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures, and that can be accessed by a general-purpose or special-purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general-purpose computer, particular purpose computer, or special purpose processing device to perform a certain function or group of functions.

“Communication media” typically embodies computer-readable instructions, data structures, program modules, or other data in a modulated data signal such as a carrier wave or other transport mechanism and includes any information delivery media.

“Modulated data signal” refers to a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless medium. In addition, combinations of those mentioned above are included within the scope of computer-readable media.

When the subject matter is embodied in the general context of computer-executable instructions, the embodiment may comprise program modules executed by one or more systems, computers, or other devices. Generally, program modules include routines, programs, objects, components, data structures, and the like, which perform particular tasks or implement abstract data types. Typically, the functionality of the program modules may be combined or distributed as desired in various embodiments.

Operating environments in which embodiments of the present disclosure may be implemented are well-known. In a representative embodiment, a computing device, such as a mobile device, is connectable to a transmission functionality that varies depending on implementation. Thus, for example, where the operating environment is a wide-area wireless network (e.g., a 2.5G network, a 3G network, or a 4G network), the transmission functionality comprises one or more components such as a mobile switching center (MSC) (an enhanced ISDN switch that is responsible for call handling of mobile subscribers), a visitor location register (VLR) (an intelligent database that stores temporarily data required to handle calls set up or received by mobile devices registered with the VLR), a home location register (HLR) (an intelligent database responsible for the management of each subscriber's records), one or more base stations (which provide radio coverage with a cell), a base station controller (BSC) (a switch that acts as a local concentrator of traffic and provides local switching to effect handover between base stations), and a packet control unit (PCU) (a device that separates data traffic coming from a mobile device). The HLR also controls certain services for incoming calls. Of course, the present disclosure may be implemented in other and next-generation mobile networks and devices.

The “mobile device” is the physical equipment used by the end-user, typically a subscriber to the wireless network. Typically, a mobile device is a 2.5G-compliant device, 3G-compliant device, or a 4G-compliant device that includes a subscriber identity module (SIM), which is a smart card that carries subscriber-specific information, mobile equipment (e.g., radio and associated signal processing devices), a user interface or a man-machine interface (MMI), and one or more interfaces to external devices (e.g., computers, PDAs, and the like). The mobile device may also include a memory or data store. The presently disclosed subject matter is now described in more detail.

When elements are referred to as being “connected” or “coupled,” the elements can be directly connected or coupled together, or one or more intervening elements may also be present. In contrast, when elements are referred to as being “directly connected” or “directly coupled,” no intervening elements are present.

In certain embodiments, the machine translation system used in the real-time interpretation method can be a neural machine translation (NMT) system, which leverages advanced deep learning techniques to improve translation quality and maintain context throughout the translation process.

In certain embodiments, the interpretation process may consider at least one feature chosen from the speaker's or user's demographic, age, slang, region, cultural context, or domain-specific knowledge. This can enhance the accuracy of the translation and provide customized outputs tailored to the user.

In certain embodiments, the real-time interpretation method accurately communicates the speaker's intention while considering various aspects of the context-aware machine translation and additional factors, such as dialect and colloquialisms, to provide more precise translations.

In certain embodiments, the extracted speech may be obtained from one or more input sources chosen from audio, video, or text files. By providing flexibility in input sources, the system can cater to a wide range of applications and user requirements.

In certain embodiments, the real-time interpretation method may preprocess the extracted speech to segment and/or filter relevant data for transcription and/or context-aware interpretation. This preprocessing helps improve the speed, accuracy, and overall performance of the interpretation process.

In certain embodiments, the real-time interpretation method may include selecting at least one target language for translation, allowing users to receive interpreted outputs in their desired languages.

In certain embodiments, the interpreted output may be exported as a SubRip Subtitle file, providing a convenient and widely used format for adding subtitles to video content.

In certain embodiments, the real-time interpretation method may display the interpreted output as subtitles in a video file within a video player, facilitating seamless integration with media playback and enhancing user experience.

In certain embodiments, the method may involve extracting embedded speech information in a source language from an audio or a video file to produce the extracted speech. This extraction allows the system to isolate and process speech content for further translation.

In certain embodiments, the audio or video file may contain non-speech information, and the method may further include parsing the extracted speech from the non-speech information before transcribing it into text. This parsing step ensures that relevant speech information is processed for interpretation.

In certain embodiments, the audio or video file may be generated in real-time by a user, and the method may involve displaying the interpreted text as a text stream on a display while the user generates the audio or video file, enabling real-time translations during live events, conferences, or video calls.

In certain embodiments, the real-time interpretation method may link the audio or video file through a URL or a magic link via email, providing users with easy access to the translated content.

In certain embodiments, the real-time interpretation method may refine and improve the interpretation using user feedback and/or self-correction algorithms while dynamically adapting the machine translation system. This continuous improvement process ensures that translations become more accurate and effective over time.

In certain embodiments, a computerized method for multi-modal interpretation and translation is provided. This method involves extracting speech and/or non-verbal data streams from one or more input sources, such as audio, video, or text files in real-time or from stored data. The extracted input is then preprocessed to segment and/or filter relevant data for transcription and/or context-aware interpretation.

In certain embodiments, preprocessed speech segments are transcribed into text, and/or semantic content is extracted from non-verbal data streams. The transcribed text and/or semantic content are interpreted using a context-aware neural machine translation (NMT) system. This system produces an interpreted output by considering factors such as the speaker's intent, the user's context, the cultural context, or domain-specific knowledge. The NMT system translates the extracted speech and/or non-verbal data from a source language and modality into one or more target languages or modalities of the interpreted output.

In certain embodiments, the interpretation is refined and improved by dynamically adapting the NMT system using user feedback and/or self-correction algorithms. The interpreted output is then exported in one or more user-configurable formats, which may include, but are not limited to, text, speech, visual aids, or interactive media.

In certain embodiments, a computerized method for integrating speech extraction, translation, and additional services includes extracting speech from one or more input sources, transcribing the extracted speech into text, interpreting the text using a context-aware machine translation system to produce an interpreted output, processing the interpreted output through additional services chosen from transcription, summarization, semantic analysis, or sentiment analysis, and exporting the processed output.

In certain embodiments, a computerized method for handling out-of-vocabulary words and other linguistic challenges involves transcribing extracted speech into text, detecting linguistic challenges chosen from out-of-vocabulary words, homophones, idioms, and ill-formed input, interactively resolving detected challenges through dialogue with a user, interpreting the resolved text using a context-aware machine translation system to produce an interpreted output, and exporting the interpreted output.

In certain embodiments, a computerized method for assessing translation reliability includes transcribing extracted speech into text, interpreting the text using a context-aware machine translation system to produce an interpreted output, determining the reliability of the interpreted output, incorporating reliability assessment for user input or target sentence re-determination, and exporting the assessed output.

In certain embodiments, a computerized method for providing multilingual closed captioning and subtitling for video content entails extracting speech from video content having a video timeline, transcribing the extracted speech into text, interpreting the text using a context-aware machine translation system to produce an interpreted output, synchronizing the interpreted output with the video timeline, and exporting the multilingual closed captions and subtitles.

In certain embodiments, a computerized method for simultaneous interpretation includes extracting speech or data in a source language, interpreting the extracted speech or data using a context-aware machine translation system with minimal delay to produce an interpreted output, and exporting the interpreted output in a target language for real-time presentation.

In certain embodiments, the method comprises a delay between input and output, for example, between 1 and 10 seconds, such as about 1 second, about 2 seconds, about 3 seconds, about 4 seconds, about 5 seconds, about 6 seconds, about 7 seconds, about 8 seconds, about 9 seconds, or 10 seconds. This delay provides time for system buffering and error failsafe, for example, during live broadcasts. In certain embodiments, the delay is 6 seconds.

In certain embodiments, a computerized method for language identification and adaptation in context-aware machine translation consists of extracting speech from one or more input sources, detecting the source language of the extracted speech using a machine translation system, adjusting settings of the machine translation system based on the detected language, transcribing the extracted speech into text, interpreting the text using a context-aware machine translation system to produce an interpreted output, and exporting the interpreted output.

In certain embodiments, a computerized method for customized and personalized translation involves extracting speech from one or more input sources, transcribing the extracted speech into text, retrieving user-specific preferences, context, and history, such as domain-specific vocabulary, dialects, or language nuances, interpreting the text using a context-aware machine translation system that incorporates user-specific preferences, context, and history to produce a customized and personalized interpreted output, and exporting the interpreted output.

In certain embodiments, a computerized method for multi-speaker translation includes detecting and separating multiple speakers' input from one or more input sources, extracting speech for each of the separated speaker inputs, transcribing the extracted speech from each speaker into text, interpreting the text for each speaker using a context-aware machine translation system to produce an interpreted output, and exporting the interpreted output for each speaker.

In certain embodiments, a computerized method for translation in noise-sensitive or confidential environments comprises extracting low-volume or encrypted speech from one or more input sources using noise-reduction or decryption techniques, transcribing the extracted speech into text, interpreting the text using a context-aware machine translation system to produce an interpreted output, and exporting the interpreted output in a secure or privacy-preserving manner.

In certain embodiments, a non-transitory computer readable medium storing instructions, which when executed by a processor, performs a method for integrating speech extraction, translation, and additional services. The method comprises extracting speech from one or more input sources, transcribing the extracted speech into text, interpreting the text using a context-aware machine translation system to produce an interpreted output, processing the interpreted output through additional services chosen from transcription, summarization, semantic analysis, or sentiment analysis, and exporting the processed output.

In certain embodiments, a non-transitory computer readable medium stores instructions, which when executed by a processor, performs a method for handling out-of-vocabulary words and other linguistic challenges. The method involves transcribing extracted speech into text, detecting linguistic challenges chosen from out-of-vocabulary words, homophones, idioms, and ill-formed input, interactively resolving detected challenges through dialogue with a user, interpreting the resolved text using a context-aware machine translation system to produce an interpreted output, and exporting the interpreted output.

In certain embodiments, a non-transitory computer readable medium stores instructions, which when executed by a processor, performs a method for assessing translation reliability. The method comprises transcribing extracted speech into text, interpreting the text using a context-aware machine translation system to produce an interpreted output, determining the reliability of the interpreted output, incorporating reliability assessment for user input or target sentence re-determination, and exporting the assessed output.

In certain embodiments, a non-transitory computer readable medium stores instructions, which when executed by a processor, performs a method for providing multilingual closed captioning and subtitling for video content. The method includes extracting speech from video content having a video timeline, transcribing the extracted speech into text, interpreting the text using a context-aware machine translation system to produce an interpreted output, synchronizing the interpreted output with the video timeline, and exporting the multilingual closed captions and subtitles.

In certain embodiments, a non-transitory computer readable medium stores instructions, which when executed by a processor, performs a method for simultaneous interpretation. The method involves extracting speech or data in a source language, interpreting the extracted speech or data using a context-aware machine translation system with minimal delay to produce an interpreted output, and exporting the interpreted output in a target language for real-time presentation.

In certain embodiments, a non-transitory computer readable medium stores instructions, which when executed by a processor, performs a method for language identification and adaptation in context-aware machine translation. The method consists of extracting speech from one or more input sources, identifying a source language of the extracted speech using a machine translation system, adjusting settings for the machine translation system based on the detected source language, transcribing the extracted speech into text, interpreting the text using a context-aware machine translation system to produce an interpreted output, and exporting the interpreted output.

In certain embodiments, a non-transitory computer readable medium stores instructions, which when executed by a processor, performs a method for customized and personalized translation. The method involves extracting speech from one or more input sources, transcribing the extracted speech into text, retrieving user-specific preferences, context, and history, such as domain-specific vocabulary, dialects, or language nuances, interpreting the text using a context-aware machine translation system that incorporates user-specific preferences, context, and history to produce an interpreted output, and exporting the interpreted output.

In certain embodiments, a non-transitory computer readable medium stores instructions, which when executed by a processor, performs a method for multi-speaker translation. The method includes detecting and separating multiple speakers' input from one or more input sources, extracting speech for each of the separated speaker inputs, transcribing the extracted speech from each speaker into text, interpreting the text for each speaker using a context-aware machine translation system to produce an interpreted output, and exporting the interpreted output for each speaker.

In certain embodiments, a non-transitory computer readable medium stores instructions, which when executed by a processor, performs a method for translation in noise-sensitive or confidential environments. The method comprises extracting low-volume or encrypted speech from one or more input sources using noise-reduction or decryption techniques, transcribing the extracted speech into text, interpreting the text using a context-aware machine translation system to produce an interpreted output, and exporting the interpreted output in a secure or privacy-preserving manner.

In certain embodiments, a speech extraction, translation, and additional services integration system includes a speech extraction module configured to extract speech from one or more input sources, a transcription module configured to transcribe the extracted speech into text, a context-aware machine translation module configured to interpret the text to produce an interpreted output, an additional services processing module configured to process the interpreted output through additional services chosen from transcription, summarization, semantic analysis, or sentiment analysis, and an exporting module configured to export the processed output.

In certain embodiments, a linguistic challenge handling system comprises a transcription module configured to transcribe extracted speech into text, a challenge detection module configured to detect linguistic challenges chosen from out-of-vocabulary words, homophones, idioms, and ill-formed input, an interactive resolution module configured to resolve detected challenges through dialogue with a user, a context-aware machine translation module configured to interpret the resolved text to produce an interpreted output, and an exporting module configured to export the interpreted output.

In certain embodiments, a translation reliability assessment system includes a transcription module configured to transcribe extracted speech into text, a context-aware machine translation module configured to interpret the text and produce an interpreted output, a reliability determination module configured to determine the reliability of the interpreted output, a reliability incorporation module configured to incorporate the reliability assessment for user input or target sentence re-determination, and an exporting module configured to export the assessed output.

In certain embodiments, a multilingual closed captioning and subtitling system for video content comprises a speech extraction module configured to extract speech from video content having a video timeline, a transcription module configured to transcribe the extracted speech into text, a context-aware machine translation module configured to interpret the text to produce an interpreted output, a synchronization module configured to synchronize the interpreted output with the video timeline, and an exporting module configured to export the multilingual closed captions and subtitles

In certain embodiments, a simultaneous interpretation system includes a speech or data extraction module configured to extract speech or data in a source language, a context-aware machine translation module configured to interpret the extracted speech or data with minimal delay to produce an interpreted output, and an exporting module configured to export the interpreted output in a target language for real-time presentation.

In certain embodiments, a language identification and adaptation system for context-aware machine translation consists of a speech extraction module configured to extract speech from one or more input sources, a language identification module configured to identify a source language of the extracted speech using a machine translation system, a settings adjustment module configured to adjust settings of the machine translation system based on the identified source language, a transcription module configured to transcribe the extracted speech into text, a context-aware machine translation module configured to interpret the text and produce an interpreted output, and an exporting module configured to export the interpreted output.

In certain embodiments, a customized and personalized translation system involves a speech extraction module configured to extract speech from one or more input sources, a transcription module configured to transcribe the extracted speech into text, a user-specific information retrieval module configured to retrieve user-specific preferences, context, and history, such as domain-specific vocabulary, dialects, or language nuances, a context-aware machine translation module configured to interpret the text incorporating the user-specific preferences, context, and history and to produce an interpreted output, and an exporting module configured to export the interpreted output

In certain embodiments, a multi-speaker translation system includes a speaker detection and separation module configured to detect and separate multiple speakers' input from one or more input sources, a speech extraction module configured to extract speech for each of the separated speaker inputs, a transcription module configured to transcribe the extracted speech from each speaker into text, a context-aware machine translation module configured to interpret the text for each speaker to produce an interpreted output, and an exporting module configured to export the interpreted output for each speaker.

In certain embodiments, a translation system for noise-sensitive or confidential environments comprises a speech extraction module configured to extract low-volume or encrypted speech from one or more input sources using noise-reduction or decryption techniques, a transcription module configured to transcribe the extracted speech into text, a context-aware machine translation module configured to interpret the text and produce an interpreted output, and an exporting module configured to export the interpreted output in a secure or privacy-preserving manner.

The present disclosure may be understood by reference to the following detailed description, taken in conjunction with the drawings as described above. For illustrative clarity, certain elements in various drawings may not be drawn to scale, may be represented schematically or conceptually, or otherwise may not correspond exactly to certain physical configurations of embodiments.

Although the disclosure described herein is susceptible to various modifications and alternative iterations, specific embodiments thereof have been described in greater detail above. It should be understood, however, that the detailed description of the composition is not intended to limit the disclosure to the specific embodiments disclosed. Rather, it should be understood that the disclosure is intended to cover all modifications, equivalents, and alternatives falling within the spirit and scope of the disclosure as defined by the claim language.

### Definitions

When introducing elements of the present disclosure or the embodiments(s) thereof, the articles “a,” “an,” “the,” and “said” are intended to mean that there are one or more of the elements. The terms “comprising,” “including,” and “having” are intended to be inclusive and mean that there may be additional elements other than the listed elements.

“Artificial intelligence,” or “AI,” refers to intelligence demonstrated by machines lacking consciousness and emotionality. “Strong” AI is usually labeled as artificial general intelligence (AGI), while attempts to emulate “natural” intelligence have been called artificial biological intelligence (ABI). An “intelligent agent” is any device or software that perceives its environment and takes actions that maximize its chance of achieving its goals. Generally, “artificial intelligence” often describes machines that mimic “cognitive” functions that humans associate with the human mind, such as “learning” and “problem-solving.” As such, an “artificial intelligence agent” refers to a non-human artificial intelligence machine that mimics human cognition via learning and problem-solving.

As used herein, “AI-driven” refers to using AI to aid or perform tasks in certain embodiments. In some embodiments, AI is used to emulate “natural” intelligence. An AI-driven system or device uses intelligent agents; any software or device that perceives its environment and takes action to achieve its goals. AI-driven systems often include machines that mimic “cognitive” functions that humans associate with the human mind, such as “learning” and “problem-solving.” In certain embodiments, an “AI-driven” system or device refers to a machine that mimics human cognition through learning and problem-solving via AI.

As used herein, “AI-driven technique” refers to a method that uses AI to aid or perform a process in certain embodiments. AI-driven techniques can be used for a variety of processes and include the use of machines that mimic “cognitive” functions, such as “learning” and “problem-solving,” to perform a task or process. In certain embodiments, an AI-driven technique can interpret and translate speech in real-time via a context-aware machine translation system. These techniques can consider various features, such as demographic, slang, and cultural context, among others, to accurately communicate the speaker's intent. Additionally, AI-driven techniques can identify the source language, adjust the machine translation system settings, and incorporate user-specific preferences in context-aware translations. Overall, an AI-driven technique refers to using artificial intelligence to aid or perform a process in certain embodiments, often including using machines that mimic cognitive functions such as learning and problem-solving.

As used herein, “context-aware” refers to computational systems, applications, devices, or Artificial Intelligence (AI) technologies to recognize, understand, and adapt to various contextual factors, including, but not limited to, user attributes, environmental conditions, historical data, or the social and cultural context surrounding a given event or interaction. In certain embodiments, context-aware systems integrate information from diverse sources, such as sensors, user inputs, databases, or external services, to provide personalized, adaptive, and anticipatory responses or recommendations tailored to each specific situation or user.

As used herein, “context-aware machine translation system” refers to a computer-based program that uses AI algorithms to automatically translate text or speech from one language to another while simultaneously considering the context of the translated content. In certain embodiments, context-aware machine translation systems are programmed to aid the translation process by incorporating knowledge about the context of the content being translated, such as the language of the source, the cultural context, and the linguistic nuances of the target language.

As used herein, “decryption” refers to converting encrypted information, data, or messages, which have been obscured or transformed through the application of a cryptographic algorithm, back into their original, readable, or intelligible form by using the corresponding decryption key or algorithm. In certain embodiments, decryption is a component of various cryptographic systems, protocols, or communication methods, ensuring the confidentiality, integrity, and secure transmission of sensitive, personal, or confidential data across networks, devices, or storage environments, while preventing unauthorized access, disclosure, or tampering. In other embodiments, decryption is employed in diverse applications, such as secure communication channels, digital signatures, electronic transactions, or authentication processes, to provide privacy-preserving mechanisms, trust, and integrity within the digital landscape.

As used herein, “demographic” refers to statistical data or characteristics relating to a specific group of people within a population, often segmented and analyzed based on factors such as age, gender, ethnicity, educational attainment, income level, geographic location, or other relevant attributes, which help to identify, understand, or describe patterns, trends, or market segments. In certain embodiments, demographic data is gathered, processed, and interpreted through various data collection methods, combining primary or secondary data sources, surveys, or census information, as well as leveraging big data analytics, statistical modeling, or machine learning techniques to drive actionable insights, inferences, or predictions.

As used herein, “dialect” refers to a specific form or variety of a language characteristic of a particular demographic, geographic region, social group, or cultural community, often distinguished by lexical, phonetic, grammatical, or idiomatic features that set it apart from other dialects or the standard language.

As used herein, “domain-specific knowledge” refers to the technical information, expertise, terminology, or concepts of a particular field, industry, discipline, or subject area, often encompassing theoretical frameworks, empirical findings, or practical insights gained through research, experimentation, or practice within that specific domain. In certain embodiments, domain-specific knowledge aids the development of advanced applications, services, or technologies that address the challenges or opportunities within a given domain, leading to specialized solutions tailored to the respective field.

As used herein, “embedded speech information” refers to the additional layers of meaning, context, emotion, or communicative intent conveyed within spoken language through non-lexical elements, such as prosody, pitch, intonation, stress, rhythm, or speech rate, as well as the speaker's voice quality, articulation, or accent, which collectively contribute to the interpretation and perception of the spoken content by listeners. In certain embodiments, embedded speech information conveys emotions, emphasis, sarcasm, and/or other pragmatic aspects of spoken communication, affecting the listener's understanding, reaction, or comprehension of the underlying message.

As used herein, “encrypted” refers to information, data, or messages that have been transformed or obscured through a cryptographic algorithm, rendering the content unreadable or unintelligible without the appropriate decryption key or process that reverses the encryption. In certain embodiments, encryption techniques encompass various methods or encryption schemes, such as symmetric-key cryptography, asymmetric-key cryptography, or other cryptographic protocols, tailored to secure the confidentiality, integrity, or authenticity of sensitive, personal, or confidential data during transmission, storage, or processing across networks, devices, or systems. In other embodiments, encrypted data are a component of various security mechanisms or privacy-preserving technologies, including secure communication channels, encrypted storage, digital signatures, or electronic transactions, to protect data from unauthorized access, disclosure, tampering, or cyber threats.

As used herein, “homophone” refers to two or more words or lexical units within a language that share the same pronunciation, often differing in spelling, meaning, or grammatical function, leading to ambiguity or confusion when interpreting spoken or written language. In certain embodiments, homophones arise from natural evolution of a language, dialectal variations, or phonological changes, reflecting the richness, diversity, and complexity of human languages.

As used herein, “ill-formed input” refers to data, text, or other forms of input that deviate from the standard grammatical, syntactical, or structural rules and conventions of a given language or system, potentially leading to ambiguity, misunderstanding, or the inability to be accurately processed, parsed, or interpreted by computational systems, natural language processing tools, or human readers. In certain embodiments, ill-formed input may encompass, but is not limited to, improper syntax, incorrect grammar, ambiguous referencing, incomplete or fragmented sentences, typographical errors, or violations of language-specific or system-specific rules. In other embodiments, handling or processing ill-formed input in various technologies or applications involves applying specialized algorithms, error-correction techniques, or robust models which identify, correct, or adapt to such deviations, thereby improving the overall efficiency, accuracy, or resilience of the language processing or computing system when faced with non-standard or noisy input data.

As used herein, an “intelligent virtual assistant” (IVA) or “intelligent personal assistant” (IPA), or “virtual assistant,” refers to a software agent that can perform tasks or services for an individual based on commands or questions. The term “chatbot” is sometimes used to refer to virtual assistants generally or accessed explicitly by online chat. In certain embodiments, that virtual assistant interprets human speech and responds via synthesized voices.

As used herein, “linguistic challenge” refers to the difficulties or complexities encountered in understanding, processing, or generating human language, accounting for its various aspects, such as grammar, syntax, semantics, pragmatics, or phonetics, which can pose obstacles for human cognition, machine learning models, natural language processing tools, or AI systems. In certain embodiments, linguistic challenges encompass but are not limited to ambiguity, idiomatic expressions, homophones, figurative language, domain-specific terminology, or cultural nuances, which often use sophisticated, context-aware, or rule-based techniques for accurate interpretation or representation.

As used herein, “machine translation” refers to the automated process of translating text or speech from a source language to a target language using computational systems, algorithms, or artificial intelligence techniques, with the goal of accurately conveying the meaning, context, and nuances of the original content while adhering to the linguistic, cultural, and stylistic conventions of the target language. In certain embodiments, machine translation approaches encompass rule-based, statistical, neural, or hybrid methods, often incorporating natural language processing, machine learning, or other language processing technologies to enhance the translation quality, fluency, and comprehensibility. In other embodiments, machine translation is employed across diverse applications, including real-time interpretation, content localization, language learning, or multilingual communication, seeking to bridge language barriers and aid global understanding or information exchange.

As used herein, “magic link” refers to a time-limited, single-use electronic token or URL that, in certain embodiments, is automatically generated upon a user's request for authentication or authorization to access an online resource or service. The magic link is delivered to a specified destination, such as an email address or a mobile device associated with the user's account, and in certain embodiments, after the user successfully verifies their identity by clicking, activating, or following the link within the predetermined time frame, the user is granted access to the restricted resource or service, eliminating the entry of a traditional username and password for authentication.

As used herein, “multilingual closed captioning and subtitling” refers to generating and displaying synchronized text translations and transcriptions of spoken dialogue, sound effects, or other audio content within audiovisual media, such as movies, television programs, or online videos, in multiple languages. In certain embodiments, the generated closed captions and subtitles are provided as text overlays on the visual content, making it accessible to diverse audiences, including individuals with hearing impairments, non-native speakers, or those seeking to enhance their language comprehension. In other embodiments, creating multilingual closed captioning and subtitling involves the application of machine learning algorithms, natural language processing techniques, human translation, or a combination thereof to translate and convert the audio content into accurate, understandable, and contextually appropriate text in various languages.

As used herein, “Neural Machine Translation (NMT) System” refers to a type of AI system employed in certain embodiments to automatically translate text or speech from one language to another using deep learning techniques, such as neural networks. By learning the underlying structures and patterns present in the source and target languages, an NMT system can generate translations that aid in conveying the meaning and intent of the original content with higher accuracy and fluency than traditional rule-based or statistical machine translation approaches. In certain embodiments, these systems are designed to adapt and improve translation performance over time through continuous learning from additional language data and feedback.

As used herein, “non-speech information” refers to any auditory or visual cues found within an audio or audiovisual medium without spoken language yet providing significant context, meaning, or emotional insight. In certain embodiments, non-speech information includes, but is not limited to, sounds produced by objects, natural phenomena, or living beings; musical elements such as melody, harmony, and rhythm; and non-verbal vocalizations like laughter, sighs, or exclamations. In other embodiments, non-speech information encompasses visual elements within an audiovisual medium, including gesture, facial expression, body language, and the dynamics of scene composition. In certain embodiments, this non-speech information conveys the intended meaning, atmosphere, or emotional impact of audio or audiovisual content.

As used herein, “nuances” refers to subtle distinctions, variations, or shades of meaning found in spoken or written language, human behavior, visual elements, or other means of expression, contributing to the complexity and depth of communication or understanding. In certain embodiments, nuances encompass, but are not limited to, the choice or usage of specific words, phrases, or idiomatic expressions; the tone, pitch, or emphasis within speech or text; the employment of non-verbal cues, such as gesture or facial expression; or the presence of cultural, historical, or contextual references. In other embodiments, these nuances capture the true essence, intent, or emotional impact of a given communication when processing, translating, or interpreting the information through natural language processing, AI, or human comprehension.

As used herein, “out-of-vocabulary words” refers to words, phrases, or other linguistic elements not included or recognized within a predefined vocabulary set or lexicon used by a natural language processing (NLP) system, machine translation system, or other language processing technology. In certain embodiments, out-of-vocabulary words may include, but are not limited to, uncommon terms, slang, domain-specific jargon, neologisms, or words from languages other than the primary language being processed. In other embodiments, these out-of-vocabulary words are identified and handled by implementing strategies such as subword segmentation, character-level models, or incorporating external knowledge bases to improve the overall performance, comprehension, and translation results of the language processing technology.

As used herein, “privacy-preserving” refers to methods, technologies, or protocols implemented in computing systems, including data storage, data sharing, or data processing systems, which are designed to protect sensitive, personal, or confidential information from unauthorized access, disclosure, or misuse, while maintaining the overall functionality, usability, or system performance. In certain embodiments, privacy-preserving techniques encompass but are not limited to, encryption, anonymization, pseudonymization, data minimization, or differential privacy. In other embodiments, privacy-preserving mechanisms are employed across various fields and applications, such as secure communication, data analytics, machine learning, or electronic transactions, while adhering to privacy regulations, ethical considerations, and user expectations, ensuring the protection and confidentiality of personal information.

As used herein, “real-time interpretation” refers to the process of instantly converting spoken or signed language from one language to another during live communication, events, or presentations, intending to aid seamless linguistic understanding between participants who may not share a common language. In certain embodiments, real-time interpretation employs a machine-driven interpretation system using natural language processing, automatic speech recognition, machine learning algorithms, or other AI techniques. In other embodiments, real-time interpretation is provided through various modalities, such as remote interpretation via teleconferencing or video streaming platform or automated speech-to-text translation displayed as subtitles or closed captions, each tailored to preserve the meaning, context, and cultural nuances of the original language while minimizing delays or interruptions in communication.

As used herein, “semantic analysis” refers to extracting, understanding, and interpreting the meaning and relationships of words, phrases, sentences, or larger units of text within a given context, accounting for syntax, word sense disambiguation, and linguistic or cultural nuances. In certain embodiments, semantic analysis is performed using natural language processing, machine learning algorithms, knowledge bases, or other AI techniques to analyze, process, and represent the underlying meaning of the text in a structured, machine-readable format. In other embodiments, semantic analysis is employed across various applications, such as sentiment analysis, text summarization, information extraction, dialog systems, translation services, or content classification.

As used herein, “slang” refers to informal, non-standard language, including words, phrases, idioms, or expressions, that originate and evolve within specific social, regional, or cultural groups, often characterized by their vivid, creative, or playful nature, and primarily used in casual, familiar, or intimate communication settings. In certain embodiments, slang encompasses, but is not limited to, colloquialisms, jargon, neologisms, or abbreviations, which may reflect or embody the attitudes, beliefs, or values of the community that employs them.

As used herein, “speech extraction” refers to isolating and identifying specific speech signals or segments within an audio or audiovisual recording, often in various forms of background noise, interference, or overlapping signals from multiple speakers. In certain embodiments, speech extraction aims to enhance the quality, intelligibility, or focus on a target speaker by employing techniques such as noise reduction, source separation, beamforming, or adaptive filtering.

As used herein, “sentiment analysis” refers to the computational process of identifying, quantifying, and categorizing opinions, emotions, or attitudes expressed in text, speech, or other means of communication, typically into categories such as positive, negative, or neutral, to gauge the writer or speaker's subjective stance, feelings, or intentions. In certain embodiments, sentiment analysis techniques encompass various approaches, including linguistic, rule-based, machine learning, or deep learning methods, incorporating natural language processing, text mining, or AI.

As used herein, “SubRip Subtitle file” refers to a plaintext format employed to store and convey time-synced subtitle information for videos, movies, or other multimedia content. SubRip Subtitle files enable the display of text captions synchronized with the video playback to aid viewers who might be deaf, hard of hearing, or speakers of different languages. These files contain sequence numbers, start and end timestamps, and the corresponding subtitle text, ensuring proper alignment of the captions with the visuals and audio in the multimedia content.

As used herein, “summarization” refers to the process of condensing a given input text, such as a document or a collection of documents, to generate a concise, coherent, and meaningful representation of points, ideas, or concepts contained in the original input. In certain embodiments, the generated summary is provided as an output in the form of text, wherein the output is a reduced version of the input text and is focused on the main ideas, preserving the meaning and intention of the source material. In other embodiments, the summarization process is driven by various techniques, including, but not limited to, extraction, abstraction, and fusion, with the implementation of machine learning algorithms, natural language processing techniques, or a combination thereof.

As used herein, “synchronization” refers to coordinating, aligning, or matching two or more events, actions, or data streams for their timing or sequence, ensuring that they occur or are processed simultaneously or in a predefined order, which aids proper functioning or communication in various computational systems, applications, or networks. In certain embodiments, synchronization techniques encompass, but are not limited to, time stamping, clock synchronization, buffering, or synchronization tokens or protocols. In other embodiments, synchronization aids audiovisual content production, where audio and video streams are synchronized to create a seamless experience; telecommunication systems, ensuring accurate transmission, reception, or processing of signals; or collaborative work environments, where multiple users or devices interact in real-time, requiring coordinated access to shared resources or data.

As used herein, “target language” refers to the specific language into which a piece of text, speech, or other forms of communication is to be translated or converted from its original language, known as the “source language,” aiming to accurately convey the meaning, context, and nuances of the original content while accommodating the linguistic, cultural, and stylistic differences between the source and target languages. In certain embodiments, target languages encompass a wide range of natural or constructed languages, dialects, or variations and are determined based on user preferences, system requirements, or application-specific needs. In other embodiments, translation, interpretation, or localization services use various methods, tools, or resources.

As used herein, “text stream” refers to a continuous or semi-continuous sequence of text, characters, symbols, or words generated, processed, or transmitted in real-time or sequentially, often originating from various sources, such as social media feeds, news articles, online forums, or conversation threads. In certain embodiments, text streams convey information, ideas, discussions, or narratives, dynamically changing and expanding as new content is added or updated. In other embodiments, processing and analyzing text streams involves applying natural language processing techniques, text mining, or machine learning algorithms, catering to tasks such as sentiment analysis, topic detection, trend monitoring, anomaly detection, or document summarization.

As used herein, “transcription” refers to converting spoken language, audio recordings, or multimedia content containing speech into a written or textual format, capturing verbatim or meaningful information of the original speech content while preserving its context, intent, and nuances. In certain embodiments, transcription can be performed using manual methods involving human transcribers or stenographers, or automated methods, which employ technologies such as automatic speech recognition, natural language processing, or machine learning algorithms. In other embodiments, transcription services cater to a variety of applications and domains, including but not limited to legal proceedings, medical dictation, academic lectures, interviews, conference calls, or closed captions for audiovisual content to make spoken information accessible, searchable, or analyzable in its written or textual form.

As used herein, “translation reliability” refers to the level of consistency, accuracy, and quality maintained while translating text or speech from a source language to a target language, ensuring that the meaning, context, and nuances of the original content are faithfully conveyed while adhering to the linguistic, cultural, and stylistic conventions of the target language. In certain embodiments, translation reliability is measured through metrics or evaluation methods, such as BLEU, METEOR, or human evaluation, comparing the translated output to reference translations or assessing the degree of preservation of meaning and context.

As used herein, “URL” refers to the Uniform Resource Locator, a standardized address or identifier used to locate and access resources, such as websites, documents, images, or multimedia content, on the Internet or other networks. In certain embodiments, a URL is composed of various elements, including the scheme or protocol (e.g., HTTP or HTTPS), the domain name, and the specific resource location within the domain's directory structure, providing a reference that web browsers or other applications can use to retrieve the associated resource. In other embodiments, URLs permit web navigation, linking, sharing, or referencing content online. They are subject to rules, standards, or conventions that ensure usability, interoperability, and proper functioning within the global network infrastructure.

Having described the disclosure in detail, it will be apparent that modifications and variations are possible without departing from the scope of the disclosure defined in the appended claims.

What is claimed is:

1. A computerized method of real-time interpretation, comprising:
transcribing to extracted speech from a speaker into text;
interpreting the transcribed text for a user using a context-aware machine translation system to produce an interpreted output, wherein the interpretation considers the speaker's intent and the user's context to translate the extracted speech from a source language into at least one target language of the interpreted output; and
exporting the interpreted output.

2. The method of claim 1, wherein the machine translation system is a neural machine translation (NMT) system.

3. The method of claim 1, wherein the interpretation considers at least one feature chosen from the speaker's or user's demographic, age, slang, region, cultural context, or domain-specific knowledge.

4. The method of claim 1, wherein the interpretation accurately communicates the speaker's intention.

5. The method of claim 1, wherein the extracted speech is obtained from one or more input sources chosen from audio, video, or text files.

6. The method of claim 1, further comprising preprocessing the extracted speech to segment and/or filter relevant data for transcription and/or context-aware interpretation.

7. The method of claim 1, further comprising selecting the at least one target language.

8. The method of claim 1, wherein the interpreted output is exported as a SubRip Subtitle file.

9. The method of claim 1, wherein, in the exporting step, the interpreted output is displayed as subtitles.

10. The method of claim 1, further comprising extracting embedded speech information in a source language from an audio or a video file to produce extracted speech.

11. The method of claim 10, wherein the audio or video file contains non-speech information, and the method further comprises parsing the extracted speech from the non-speech information before the transcribing step.

12. The method of claim 10, wherein the audio or video file is generated in real-time by a user, and, in the exporting step, the interpreted text is displayed as a text stream on a display as the user generates the audio or video file.

13. The method of claim 10, further comprising linking the audio or video file via a URL or a magic link via email.

14. The method of claim 1, further comprising refining and improving the interpretation by dynamically adapting the machine translation system using user feedback and/or self-correction algorithms.

15. A non-transitory computer readable medium storing instructions, which when executed by a processor, perform a real-time interpretation method, the method comprising:
transcribing extracted speech from a speaker into text;
interpreting the transcribed text for a user using a context-aware machine translation system to produce an interpreted output, wherein the interpretation considers the speaker's intent and the user's context to translate the extracted speech from a source language into at least one target language of the interpreted output; and
exporting the interpreted output.

16. The computer readable medium of claim 15, wherein the audio or video file contains non-speech information, and the method further comprises parsing the extracted speech from the non-speech information before the transcribing step.

17. The computer readable medium of claim 16, wherein the audio or video file is generated in real-time by a user, and, in the exporting step, the interpreted text is displayed as a text stream on a display as the user generates the audio or video file.

18. A real-time interpretation system, comprising:
a speech extraction module configured to extract speech from a speaker;
a transcription module configured to transcribe the extracted speech into text;
a context-aware machine translation module configured to interpret the transcribed text for a user, wherein the interpretation considers the speaker's intent and the user's context to translate the extracted speech from a source language into at least one target language of an interpreted output; and
an exporting module configured to export the interpreted output.

19. The system of claim 18, wherein the audio or video file contains non-speech information, and the embedded speech extraction module is further configured to parse the extracted speech from the non-speech information before the transcription module transcribes the extracted speech.

20. The system of claim 19, wherein the audio or video file is generated in real-time by a user, and the exporting module is configured to display the interpreted text as a text stream on a display as the user generates the audio or video file.
